(19) United States
(12) Patent Application Publication
(10) Pub. No.: US 2003/0191948 A1
(43) Pub. Date: Oct. 9, 2003

(54) Security method and apparatus

(76) Inventors: Kenneth Nelson, New York, NY (US); Gordon Kessler, Mt. Kisco, NY (US)

Correspondence Address: Gordon Kessler, 59 Fox Den Road, Mt. Kisco, NY, 10549, US

(21) Appl. No.: 10/117,538

(22) Filed: Apr. 5, 2002

(51) Int. Cl. H04L 9/00

(52) U.S. Cl. 713/185

(57) ABSTRACT

A secure access device utilization method and system are provided. The system comprises a central device adapted to receive one or more physical electronic keys or software implemented electronic keys. The system also comprises a remote device including a single secure access apparatus. One or more remote storage locations are each associated with one or more corresponding ones of the physical electronic keys or software implemented electronic keys. During use, the central device in accordance with the single secure access apparatus first authenticates the remote device. After authentication one of the one or more physical keys or software implemented electronic keys is requested by the remote device. Finally, the remote storage location corresponding to the requested physical key or software implemented electronic keys is accessed. Data is thereafter preferably transferred from the remote storage device to the central device and from the central device to the remote device.

### BACKGROUND OF THE INVENTION

This invention is related generally to the secure transmission of data over a computer or other data network. Because of the open nature of such data transfer networks, the provision of secure data transfer is of great importance. Therefore, it would be beneficial to provide an improved method and apparatus for facilitating a secure data transfer over a data transfer network.

### SUMMARY OF THE INVENTION

Generally speaking, in accordance with the invention, an improved method and apparatus are provided for facilitating the secure transfer of data over a data transfer network.

As a greater amount of personal information is available in computerized format, the need to secure this type of data increases. At the present time, an individual might have financial or other personal information residing on her home computer. This home computer may be continuously connected to the Internet via a cable modem, DSL line, or other communication system, or may alternatively be connected to a global publicly accessible or private computer network. Furthermore, a user may have secured one or more remote storage locations and/or remote storage devices for storing other information. Such a remote storage system allows a user to reserve a predetermined amount of storage space. This remote storage space is accessible by the user through the use of a secure access method, such as one employing an identification and password from any other computer or appropriate access device in the world. Additionally, various parties, such as doctors, accountants or any other professional or the like may maintain personal information about a patient or client (user), test results, analysis of other medical data, financial data or the like in a computer-accessible location. Remote storage devices offer various types of access. Some remote storage devices can be connected to a PC, PDA or some other I/O devices and will authenticate users based on the use of a secure access method. However, some third party remote storage devices (ie: Personal Video Recorder (TIVO®, ReplayTV®), console game box (ie: XBOX®)) currently allow users limited access to copying & moving stored media and data to other devices due to a lack of compatible software and network interface. Finally, the user may have access to additional information, data and media storage, on-demand media access maintained by a third party on a subscription-type basis. Thus, the third party may maintain information, such a music/media data that while not personal, may only be accessed by a particular user that has paid or registered for the right of access.

Currently, a user encounters many roadblocks in securing and authorizing access to all of this information. For example, a user's computer at home with various personal data contained thereon is subject to attack from others (“hacking”). A username and password are typically the method used to secure remotely stored information. This information is subject to attack by a third party obtaining the user's password or by a third party hacking the computer system of the entity maintaining the remote storage site. The same problem is noted regarding a doctor's or accountant's computer systems. Furthermore, if a user asks this information to be transferred to or accessed by another doctor or other individual, this data transfer may be intercepted. Additionally, there is no way for the user to insure that the doctor or accountant maintaining the information only transfers the personal information to other doctors or accountants authorized by the user. Finally, only a password or other minimum-security method typically secures access to a subscription service. If this password is learned by a third party, that third party will have access to all of the subscription data without paying for it. While this may not be a tremendous problem for the user, unless the subscription service allows only for a limited amount of access by a user, it is a great problem for those maintaining the subscription data.

Any numbers of methods and apparatuses have been developed in an attempt to provide a secure data transfer transaction by trying to assure that the owner or intended recipient of the data is present or is making the request. These include, among other methods, the encryption of data being transferred from one location to another. While effective, the encryption codes may be cracked. Furthermore, this encrypted data is only useful if it is being transferred between a known location of a user and a third party. Other applications of such encryption technology are very limited.

Another approach has been to provide a user a “parallel port key” physically connected to the user's computer. Upon access to a remote network, the remote system searches the local computer for the parallel port key. If present, access is granted. If the key is not present, access is not granted. However, this system allows only a single machine to access the remote network. Thus access is tied to a particular machine, not to a particular user. Furthermore, typically this parallel port key allows for access to only one remote system per key, and is therefore cumbersome if a number of secure sited are to be accessed.

Similar to this parallel port key approach is a system in which a user's remote access device includes a program for access. The user is given a key code from a detached key-generating element. This key may be generated based upon a random number, or even may be generated in accordance with a predetermined algorithm action upon a seed number received wirelessly by the key-generating element.

Likewise, breakthroughs in biometric recognition technology will also provide digital footprints and security keys based on, but not limited to, personal features such as voice recognition, fingerprint, retnal scan, and human static electric discharges and readings. Digital footprints of these authentication types can be saved directly physical devices (ie: smart cards) or can be distributed and stored on various technology device's memory. With the example of a smart card, a voice recognition pattern of a particular user can be saved onto a smart card and this will be used to authenticate a user for access to data either at a remote location or physical location.

Regardless of the system employed, these systems all use some type of authentication at the location of the user to gain access to a particular remote system. This authentication is typically limited to a single remote access device because of the requirement of installation of a particular hardware device and/or a particular software algorithm for processing various authentication procedures and commands.

Even more troubling is that each different service may use a different access system. Thus, a user may need to carry any number of the above mentioned or other access control systems to allow access to the various services from a remote location. Furthermore, because each access requires such an access system, it is not possible for a user to give access, and certainly not limited access, to a particular category of data to a third party.

Therefore, in accordance with the invention, a central security key storage apparatus is provided for housing all required physical keys and software access algorithms. This apparatus is typically provided coupled with a user's home computer, but may be provided at any location, such as, by way of example only, a television, a set top box, an apparatus connected by phone line, satellite receiver, other control device, or portable computing device. A user is provided with a single access apparatus for gaining access to the user's home computer from a remote location and then may direct various authentication procedures to any number of third party systems installed in the central security key storage apparatus. Furthermore, a user may provide third parties with a similar access apparatus for access to data. Each access apparatus is individually identified, and therefore upon accessing a user's home computer, the identity of the third party is known. Thus, the user may limit access for a particular user employing a particular access apparatus to only particular data, for particular predefined times of the day week, etc., or may even deny access until approval for a limited time is granted by the user.

In this manner, any number of access devices are maintained at a single location. The security system constructed in accordance with the invention monitors the identity of all installed access devices, and tracks the various incoming identification information and corresponding allowable outgoing identification data. In this manner, only individuals given precise access to a user's home computer, or other location containing the access devices, can use the access devices. Based upon the identity of the accessing user, only one or more of the retained access devices may be used, and only in accordance with permission granted by the home user. Furthermore, these access devices can be used by a user from any location to access remotely-stored information without actually carrying the access devices with the user.

Still other objects and advantages of the invention will in part be obvious and will in part be apparent from the specification and the drawings.

The invention accordingly comprises the several steps and the relation of one or more of such steps with respect to each of the others, and the apparatus embodying features of construction, combination(s) of elements and arrangement of parts that are adapted to effect such steps, all as exemplified in the following detailed disclosure, and the scope of the invention will be indicated in the claims.

### BRIEF DESCRIPTION OF DRAWINGS

For a more complete understanding of the invention, reference is made to the following description and accompanying drawings, in which:

FIG. 1 is a block diagram representing an overall flow of data in accordance with the user of a security apparatus constructed in accordance with the invention;

FIG. 2 is a flow chart diagram depicting an embodiment of the invention;

FIG. 3 is a flow chart diagram depicting another embodiment of the invention;

FIG. 4 is a flow chart diagram depicting a further embodiment; and

FIG. 5 is a flow chart diagram depicting yet another embodiment of the invention.

### DETAILED DESCRIPTION OF THE PREFERRED EMBODIMENT

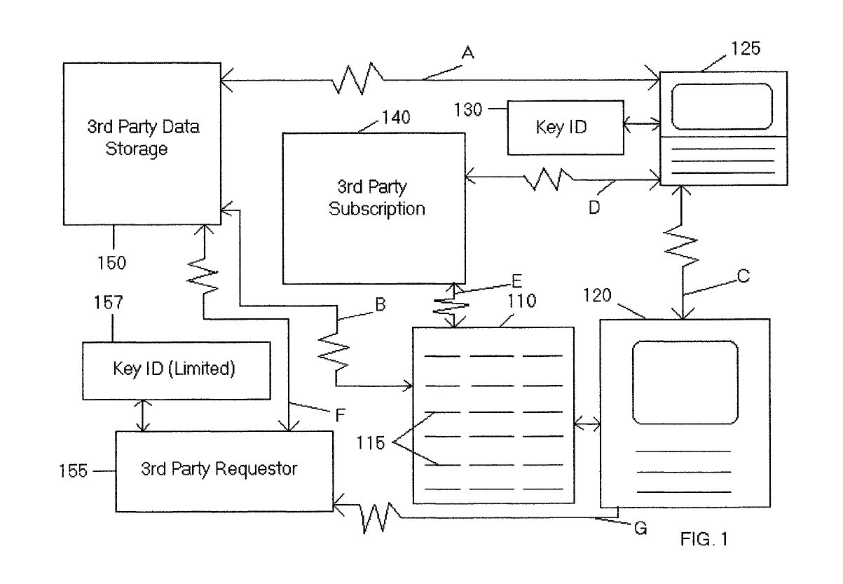

A detailed description of the invention will now be provided, making reference to the figures. In accordance with the invention, as is shown in FIG. 1, a security apparatus 110 is shown coupled with a computer 120. Security apparatus 110 includes one or more slots for receiving one or more corresponding hardware security devices. These might comprise parallel keys, wireless receiving devices, smart cards, RSA devices, or any other apparatus, such as those discussed above, that might be user for security. Also included within security apparatus 110 is an appropriate memory for retaining data that might be used as a software type of security apparatus. Therefore, security apparatus 110 may be employed with any available individual security apparatus.

Currently, and even more so in the future, data belonging to, or pertaining to a particular individual, will reside on any number of local and remote computers. Therefore, a user may have personally generated information stored on local computer, and other data stored at a third party data storage location 150. Data at this location may comprise data placed there by the individual, such a music data, video data, documents or other data. Additionally, this data may comprise personal data generated by another entity, such as medical records, tax records, accounting records, credit reports and the like. Other remotely stored data may comprise data available to a particular user in accordance with a subscription or other pay for use service stored at a remote third party subscription location 140. This type of service may comprise video or music on demand, electronic books, research data, other types of music or other digital data download service allowing a user to download the data for future use, or even a case where various research reports or other proprietary data may be obtained. While this remotely stored data may reside at a remote location, it may also reside at a user's home or business, but at another location on a computer network, LAN or the like.

Regardless of where this data is stored, one or more parties have an interest in maintaining the confidential and secure nature of the data. If the data is personal data maintained on computer 120, the individual user has an interest in keeping the data private. If the data is generated and stored at remote third party storage 150, both the generating party and the user to whom the data refers have an interest in maintaining the confidential nature of the data. In a subscription type service, it is the third party that maintains the storage location 140 who has the incentive to insure that the data is only accessed by paying customers.

Thus, security is a common thread. To maintain this security, each entity might issue its own security apparatus and procedure. Thus, as noted above a different security apparatus or software program might be required to access data at data storage 150 than to access third party subscription data 140. While a user is located at computer 120, the user is able to swap required security measures as desired based upon the service desired. Furthermore, because the user is operating computer 120, the user can clearly control the transmission of personal data from computer 120.

However, a substantial problem arises if a user wishes to access any of the types of data noted above from a remote computer 125 or other appropriate access device. First, a user would need to carry all required security devices, or load all possible security access programs for every possible desired service. Furthermore, if the remote device is a laptop of the user, these various hardware or software device might be able to be switched in and out of computer 125. However, if remote computer 125 is owned by another, such at a hotel, another's offices, a publicly available computer terminal or the like, it is unlikely to be able to regularly switch in and out various required hardware security devices. Furthermore, even if it were possible to swap in and out the devices, these devices might be designed to work with only one computer (i.e. computer 120) and would not work with another's computer. Indeed, the provision of a security device intended for only one particular host computer improves security, comprises part of the invention, and will be described below in greater detail.

Therefore, in accordance with the invention, all required security devices are maintained at a single location, in security apparatus 110. Security apparatus is designed to work with all available security devices, the construction thereof being updated as necessary to accommodate any future developed security devices. Furthermore, a remote user at computer 125 possesses a security apparatus, such as a key ID 130. This key is generated specifically for the user by security apparatus 110. When this key is used and coupled with computer 125, information is transmitted from computer 125 to computer 120 (and security apparatus 110 as necessary) verifying the identity of the user at computer 125. This identification process may require the user to enter a password, use a number generator for a code generation, may utilize a satellite receiver, or may use one or more biological identification methods, such as a retinal scan, voice recognition, fingerprint or the like. Indeed, any single security device may be employed. The point of the invention is that only one device need be used.

When key ID 130 is generated it is configured for the user and owner of computer 120. Therefore, upon establishment of communication (C) with computer 125, including the generated security device, security apparatus 110 is assured that the user and owner of computer 120 is in communication. Once this communication is established, computer 120 acts for the user at computer 125. The user is able to make various information requests at computer 125 that the user would be able to make if she were seated at computer 120.

Thus, if a user desires to access personal confidential information from computer 120, in accordance with recognition of key ID 130 by security apparatus 110, and recognition that the user of key ID 130 is the owner of computer 120 and the information contained therein, any information requested by computer 125 is transferred thereto. Furthermore, if a user desires to receive information stored at third party data storage 150, the user makes such a request at computer 125 to computer 120. Computer 120 in turn instructs security apparatus 110 to access the appropriate security device 115 associated with third party data storage 150. The security device is implemented, proper communication and authentication is performed between computer 120, security device 110 and third party data storage 150, and it appears to third party data storage 150 as if the request is being sent from computer 120. At this time one of two paths may be followed. If third party data storage 150 is a device approved to operate with security apparatus 110, even though the request appears to be coming from computer 120, part of the authentication protocol may include a different data destination address, i.e. computer 125. Thus, as is shown in FIG. 1, data (A) may be transferred from third party data storage 150 directly to computer 125. Alternatively, if this direct transfer to a third location is not approved, the requested information may be transferred first to computer 120 and security apparatus 110 from third party data storage 150 (B), and then by computer 120 to computer 125 (C). Thus, a user at a remote location can receive the requested data.

Additionally, the user may request to receive data from a third party subscription service, such as for example music, video or the like. Data transfer, when requested by the user and owner of computer 120, is performed in the same way as for third party data storage. Thus, the user makes the request at computer 125. Information employing key ID 130 is transmitted to computer 120. Key ID 130 is recognized at security apparatus 110. Upon recognition and proper authentication, a security device 115 associated with the requested third party subscription service 140 is determined. This security device is implemented, and a connection and authentication is performed between computer 120 and third party subscription service 140. After authentication, data is transferred to computer 125, either directly (D) or via computer 120 and security apparatus 110 (E). Such a subscription service is more likely to allow for the direct transfer to computer 125 because of the subscription nature of the service.

While the two examples noted above allowed an owner of computer 120 to access information from a remote location, the invention is not limited to only the owner of computer 120 having access to the data. Rather, as is shown in FIG. 1, a third party requester 155 may request information via computer 120. However in accordance with the invention, only a third party requester who has been pre-authorized by the owner of computer 120 may make this request. Thus, the user and owner of computer 120 may authorize security apparatus 110 to generate an additional key ID (limited) 157 for use by a third party requestor 155. Similar to the operation of key ID 130, third party requester 155 may be required to enter a password or other identifying indicia upon the use of key ID (limited) 157. Then upon transmission of this information to computer 120 and security apparatus 110, the third party requestor is recognized by computer 120.

However, upon recognition by computer 120, third party requestor 155 does not have full rights as does the owner of computer 120. Upon generation of key ID (limited) 157, security apparatus 110 assigns particular rights to the user of the particular key ID as defined by the owner of computer 120. Thus, for example, a doctor acting as third party requestor 155 may be given access to medical records only. These records may be maintained on computer 120, or remote third party data storage 150. It does not matter. If third party requestor 155 is authorized to obtain the medical records, security apparatus 110 will operate in a manner as noted above, to apply the appropriate security device 115, and obtain the desired records from any location as required. Similarly as noted above, this data may be sent directly to third party requestor 155 (F), or may be sent through computer 120 and security apparatus 110 (B), (G). Another key to this aspect of the invention is that the owner of computer 120 need not give unfettered access to records to a third party. Rather, the available rights are defined upon the generation of a key ID, insuring that only the intended user has access to the designated information, and that the intended user does not have access to any other information. In addition to limiting the type of information, in order to provide additional security, access at only particular times of the day may be allowed, for example.

The following is a discussion of examples of the application of this invention to various fields and types of data. The invention contemplates overcoming the difficulties of each scenario while maintaining the overall security of data contained in the system. Furthermore, this invention may be applied in any field in which a remote or limited access is desired for particular data. Thus, the system as described in FIG. 1 may be applied to any scenario in which remote access to secure information, either by the information owner or other third party is desired. The information may be stored locally or remotely, and the access to the data may be from either a remote or local location.

As is noted above, the use of this device with doctors and other medical information allows for convenient access to various information. For example, a user may store all of her medical records at home on computer 120, at remote third party data storage 150, or it may be maintained securely at one or more of her doctors' offices. It may arise that the user wishes to view the medical information, or wishes to allow another doctor, an insurance agent, or other individual to review this stored medical information. However, traditionally this type of access has been difficult to grant. However, in accordance with the invention, granting of access is simple.

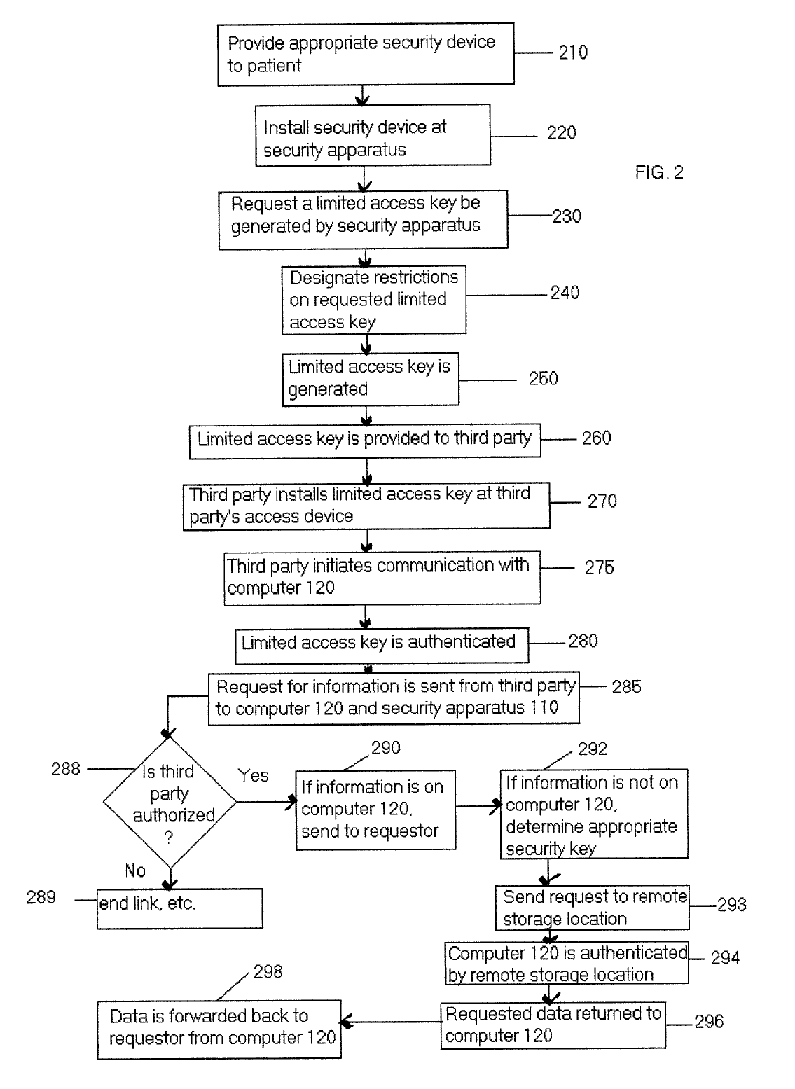

Referring to the steps shown in FIG. 2, at step 210 a patient is first provided with an appropriate individual security device for accessing the desired information, if that information is maintained at a third party location. If the information is maintained on computer 120, no additional information is required. Then at step 220, this security device is installed in security apparatus 110. At step 230 the user requests that a limited access key be generated by the security apparatus. Such a limited access key will eventually be provided to the doctor or other individual who is to be given access to the medical information. At step 240, the user designates any desired restrictions to be associated with the limited access key. These restrictions will typically include limiting the information that can be obtained with the limited access key and limiting the times of day or the duration of when the key is active. Of course, even after setting the various restrictions, at a later date the user could alter these restrictions, or render the limited access key inactive, as desired by making any desired changes at computer 120. After designation of the desired restrictions, the security apparatus generates an appropriate limited access key at step 250, and this key is provided to the third party wishing to have access to the user's medical information at step 260.

During use, the third party installs the limited access key is installed in the third party's access device, typically a computer, at step 270. Thereafter, at step 275, the user initiates communication with computer 120 via any appropriate communication method. At step 280 computer 120, in conjunction with security apparatus 110 authenticates the limited access key, also obtaining from memory any restrictions associated therewith. At step 285 a request for information sent by the third party is processed by computer 120 and security apparatus 110 in accordance with any restrictions noted above. At step 288 it is determined whether the third party and the limited access key are authorized to receive the requested information. If this inquiry is answered in the affirmative, two options are possible. First, if the requested information is included on computer 120, then at step 290, this information is forwarded back to the third party. However, if the requested information is maintained in a remote location, then at 20 step 292 security apparatus 110 determines the appropriate security device to activate corresponding to the remote location of the data. At step 293, a request is sent from computer 120 and security apparatus 110 to the appropriate remote location to obtain the requested data. At step 294 computer 120 is authenticated by the remote storage location, and after authentication, at step 296, the requested data is forwarded back to computer 120. Finally, at step 298, the requested data is forwarded back to the third party requester. Of course, if set up in an appropriate manner, the data transfer of step 296 could be directly back to the third party requester as noted above.

If, however, the inquiry at step 288 is answered in the negative, and therefore the limited access key is not authorized to receive the requested information, the third party requester is so notified, and the communication link may be terminated at step 289, the limited access key may be deactivated, or other appropriate measure may be taken. In this manner, the third party requester is given access to medical information maintained by the user locally or at a third party location, but this access is ultimately still controlled by the user.

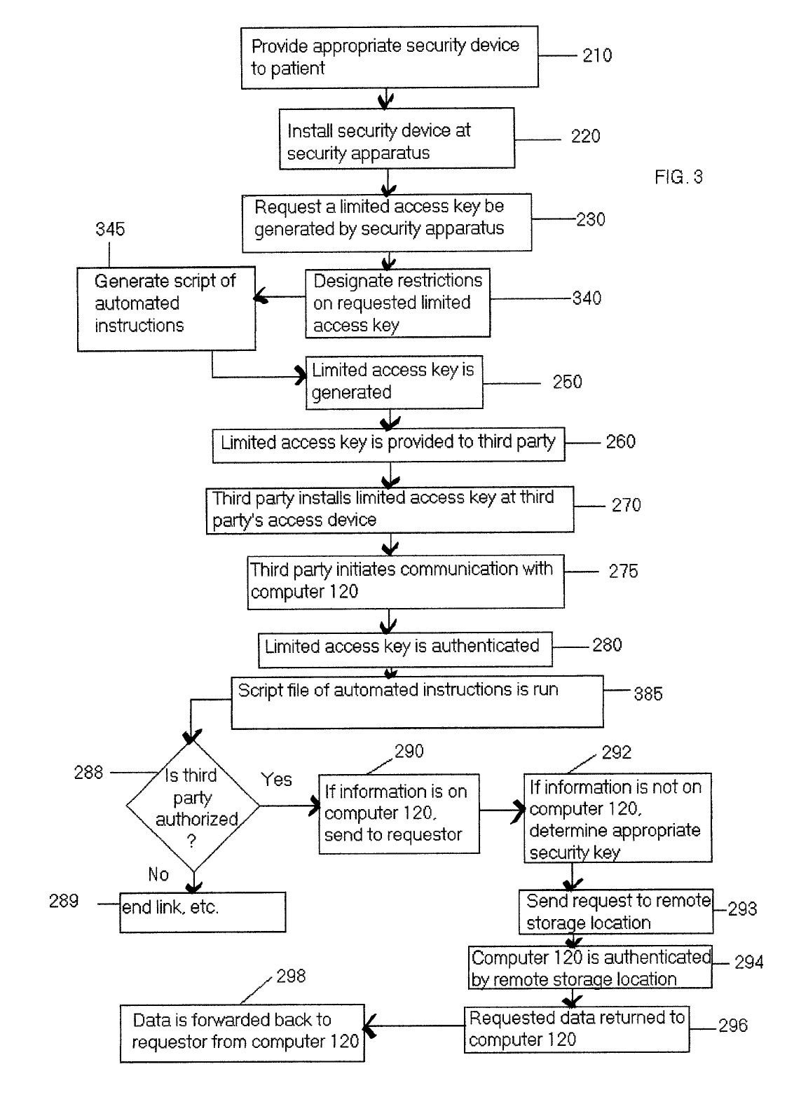

The access provided to a third party requestor may also operate on an automated basis. For example, referring next to FIG. 3, a medical patient may be required to perform some type of home testing of herself. This might include a regular blood test, blood pressure test, or any other test that might be required. The user may obtain a medical apparatus that may be coupled with computer 120 for automatically performing the test and storing the test result data, or the test may be performed manually, and the data entered into computer 120. Alternatively, samples or the like may be regularly sent to a third party lab, where the results are stored and posted to a remote storage location to which the user is provided secure access via a secure access device. Regardless of how this information is obtained once it is stored, an authorized third party requester may gain access to this information according to the method noted above. However, in this embodiment of the invention, because the various user testing takes place regularly, the limited access key generated by security apparatus 110 includes instructions for times of access, and for automatic transfer of information upon authentication.

As is shown in FIG. 3, steps similar to this in FIG. 2 are similarly designated, and will therefore not be described herein. At step 340, a user inputs restrictions to be associated with the limited access key to be generated. However, these restrictions include extremely limited times during which information may be obtained. For example, while any time may be allowed, allowing downloading this data at night when the user is asleep may be most desirable. In addition to designating this time restriction, at step 345 a of script instructions is generated to perform a predetermined number of operations to obtain the desired test data. Thus, no third party interaction is required. Upon authentication (discussed below) the script instructions are performed to transfer the appropriate information.

During operation, after authentication at step 280, at step 385 the script file is run. There is no need to determine whether the data request is appropriate, because no request is included. Rather, upon authentication, the script file, maintained at computer 120 and security apparatus 110, is run to provide data. This script file may obtain and forward data in any of the manners noted above. In this manner, desired data is transferred to the third party requester. Because of the automated nature of the steps, only the authorized data is transferred. Further, because of the automated nature of the steps, the access device of the third party requester may by instructed to automatically request this data at night, and indeed may operate without user intervention. Thus, it would be possible to obtain test information at predetermined intervals without further interaction by a user.

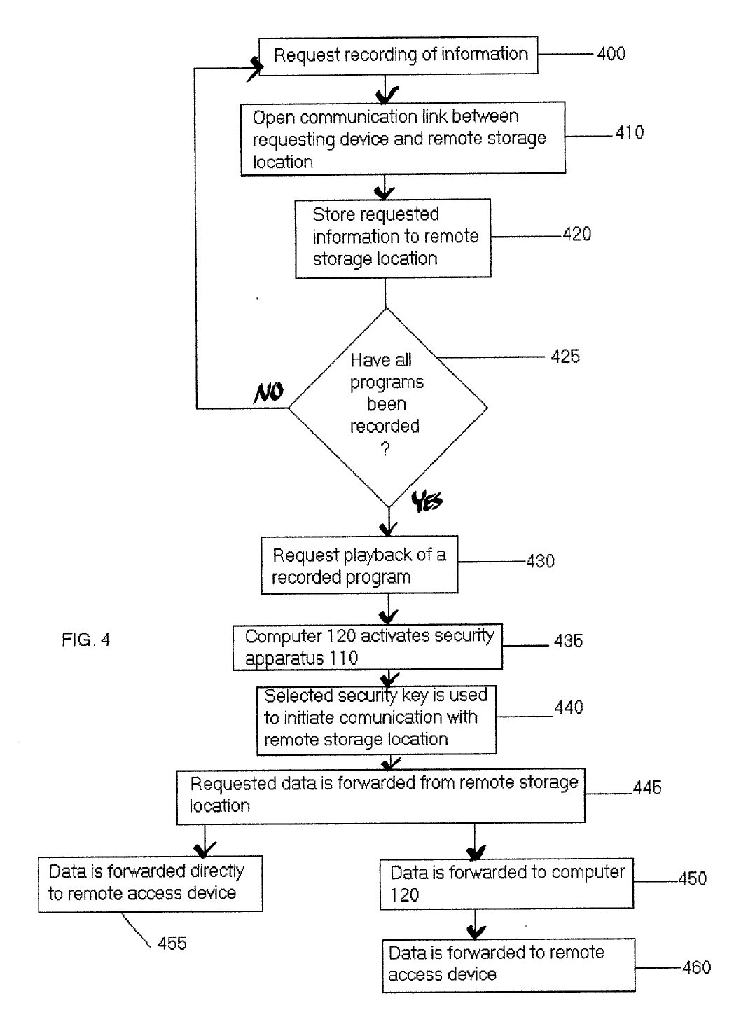

As is noted above, a user may wish to store various information at a remote location for access at a later time. This remote storage allows for access of this information from any access point. A user need not be at her computer in order to access this information. In accordance with the invention, such a remote storage is used to store various audio/video media, or electronic data information, and more specifically, to store programs requested to be digitally stored by a user. Thus as is shown in FIG. 4, a method in accordance with a further embodiment of the invention is shown.

At a step 400 a television program or other broadcast information is requested to be recorded. This request might take place using a TiVo®, ReplayTV® or other similar digital recording device. This may be an actual request by a user, or may be an automated request, such as automatically recording additional unrequested programs, but that are selected based upon a user's selection or other profile. Indeed, any recording device may be employed. Furthermore, such a device is not necessarily required. Indeed, a user may visit a website designed to accept recordation requests associated with a registered user. In any event, a request to record information is made. Next, at a step 410, shortly prior to the airing of the show to be recorded, a communication link is opened between the device requesting the recording and the remote storage location, such as third party storage 150 (see FIG. 1). This communication link may require a valid security apparatus (see FIG. 1, security apparatus 110) even to record information into the remote storage location, but this is not necessarily required. Thus, the user might be required to connect an appropriate security device to the requesting apparatus. The security apparatus will typically be positioned within the requesting apparatus, but if the requesting device is a computer, computer 120 and security apparatus 110 may be employed in accordance with the teachings above. After such a communication link has been opened, a requested program is stored to the remote storage device at step 420. This procedure continues until all desired programs are recorded, and at step 425 it is determined whether all programs have been recorded.

During use, and to retrieve data, the apparatus in accordance with the invention is employed as noted above. Specifically, at step 430 a user makes a request from a remote access device to computer 120 to retrieve the stored recorded program data. The user might be required to attach a single security device 125 to the remote access device to gain access to computer 120. At step 435 computer 120 activates security apparatus 110 to select an appropriate physical or software key, and at step 440 this selected key is used by computer 440 to initiate communication with the remote storage location storing the recorded program data. Upon authentication, at step 445, in a manner as noted above, requested data is forwarded from the remote storage location to computer 120 (step 450), or alternatively is forwarded directly to the remote access device being utilized by the user (step 455). If the data is forwarded to computer 120, then at step 460, this data is forwarded to the remote access device. The remote access device then receives the previously recorded data.

The remote access device might comprise a laptop computer or other portable device that may be connected to a television of the like, for example in a hotel room when travelling so that the user can watch previously stored television programs from any locations. The remote access device may also comprise a set top box, cable television receiver, satellite television receiver or the like, as long as it is able to receive security device 125 for secure access to computer 120. In this manner, recorded information may be securely retrieved from any location desired.

While this embodiment has been described with reference to one or more television shows that are specifically requested to be recorded by a user, it is not so limited. The system may also be employed with a broadcast service, video on demand, or the like. Therefore, a user need not request that a program be recorded. Rather, from a remote location a user would access home computer 120 and security apparatus 110. If the user had access to, for example particular programming from a satellite dish, security apparatus 110 and computer 120 could receive the broadcast information and forward the broadcast information to the user at the remote location. Similar processing may be employed with video or music on demand or the like.

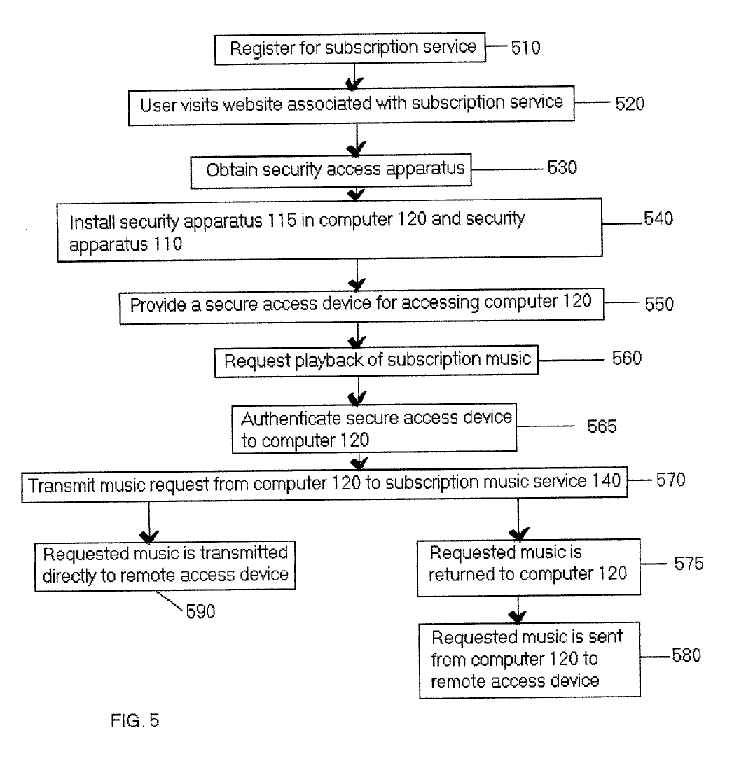

Referring next to FIG. 5, the apparatus and method may further be used with a audio, video, media broadcast, or other data subscription download and/or access service. First, at step 510 a user registers for a subscription service. This subscription service preferably comprises a music subscription service, but may comprise any additional data download service. Next, at step 520 the user typically visits a website associated with the music subscription service and selects one or more songs for playback. This selection may require payment for each song, or may be included in a standard fee. The precise operation of the subscription service and data selection is well known in the art. At step 530 the user obtains a security access apparatus, comprising one or more of the hardware or software apparatuses 115 noted above. At step 540, this security apparatus is installed at computer 120 and security apparatus 110 in a manner as noted above. In this manner, computer 120 will have secure access to the music download subscription service through the use of the security apparatus.

Thereafter, this music download information is accesses in accordance with the invention as noted above. First, at step 550 a secure access device (key ID 130) is provided for accessing computer 120. Preferably, this secure access device is adapted to be coupled with an appropriate music playback device, such as an mp3 player, PDA, portable computer, cellular telephone or the like. Then, upon a request for download of music to the music playback device at step 560, the music playback device, including the coupled secure access device is authenticated to computer 120 and security apparatus at step 565. Upon authentication this request is relayed to the subscription music service website at step 570. Computer 120 gains secure access to the music subscription service website (see FIG. 1, 140) through the use of security apparatus 10 and the secure access device provided from the music subscription service. At step 575, the requested music information is downloaded to computer 120 and is then relayed to the music playback device at step 580. Of course, as noted above rather than forwarding the requested music information to computer 120 at step 575, this information may be forwarded directly to the music playback device at step 590. This direct music transfer may be allowed, if the location of the music playback device is know to the music subscription service, and if such a direct data transfer is enabled.

Therefore, in accordance with this embodiment of the invention, secure access to a music or other data subscription service is provided. Any music or data playback device may obtain the subscription information. Furthermore, only one type of secure access device need be provided by the subscription service, because access of the music playback device to the subscription service if performed via computer 120 and secure access apparatus 110. Therefore, the subscription service provider does not consider security between the music playback device and computer 120.

In accordance with an additional embodiment of the invention related to the dissemination of personal information will be described. In accordance with this embodiment of the invention, personal user information is stored on computer 120, or alternatively is stored at remote third party data storage 150. If this information is maintained at computer 120, upon a request from a remote computing device 155 having a secure data link including key ID (Limited) 157 to computer 120 and security apparatus 110 as described above, the requested data may be forwarded to the third party 155 for automatic population of various forms or to meet other information requests. If the personal information is maintained at a remote third party data storage 150, then in accordance with the access of third party storage 150 as described above, this information may be accesses via computer 120 and security apparatus 110, and forwarded securely to the third party 155 requesting the information. This data may be forwarded via computer 120 or directly to the requesting third party to receive the information as desired by the user.

Therefore, in accordance with the invention, a secure data access and transferring system is provided. This system allows a portable device to utilize a single secure data apparatus to access various information typically requiring multiple secure data apparatuses. By maintaining these multiple secure data apparatuses in a single location, the burden on the user is reduced, and any number of remote access devices that have secure access to computer 120 and security access device 110 may utilize all of the secure data apparatus keys.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed:

1. A secure access device utilization system, comprising:
a central device adapted to receive one or more physical electronic keys;
a remote device including a single secure access apparatus;
one or more remote storage locations, each being associated with one or more corresponding ones of said physical electronic keys;
wherein said remote device is authenticated by said central device in accordance with said single secure access apparatus, one of said one or more physical keys is requested by said remote device, and said remote storage location corresponding to said requested physical key is accessed.

2. The secure access device utilization system of claim 1, wherein said single secure access apparatus comprises a parallel port key.

3. The secure access device utilization system of claim 1, wherein information retrieved from said remote location corresponding to said requested physical key is forwarded to said central device, and then forwarded to said remote device from said central device.

4. The secure access device utilization system of claim 1, wherein information retrieved from said remote location corresponding to said requested physical key is forwarded to said remote device in accordance with a location of said remote device forwarded from said remote device to said central device, and from said central device to said remote location.

5. The secure access device utilization system of claim 1, wherein said remote device comprises a computer located at a third party location.

6. The secure access device utilization system of claim 1, wherein said remote device comprises a portable data processing apparatus.

7. The secure access device utilization system of claim 1, wherein said single secure access apparatus is associated with a restricted set of capabilities.

8. The secure access device utilization system of claim 7, wherein said single secure access apparatus is adapted to gain access to said one or more physical keys only during predetermined times.

9. The secure access device utilization system of claim 7, wherein said single secure access apparatus is adapted to be authenticated by said central device during predetermined times

10. The secure access device utilization system of claim 7, wherein said single secure access apparatus is adapted to allow access to less than all of said one or more physical keys.

11. The secure access device utilization system of claim 1, wherein said remote storage location stores medical records.

12. The secure access device utilization system of claim 1, wherein said remote storage location stores audio/video data.

13. The secure access device utilization system of claim 12, wherein said audio/video data is accessible in accordance with a subscription service.

14. The secure access device utilization system of claim 1, wherein said remote storage location stores audio data.

15. A secure access method, comprising the steps of:
receiving one or more physical electronic keys at a central device, each of said one or more physical electronic keys being associated with; one or more remote storage locations,
authenticating a remote device including a single secure access apparatus by said central device in accordance with said single secure access apparatus;
requesting one of said one or more physical keys by said remote device; and
accessing said remote storage location corresponding to said requested physical key.

16. The secure access method of claim 15, further comprising the steps of:
forwarding information retrieved from said remote location corresponding to said requested physical key to said central device; and
forwarding said retrieved information to said remote device from said central device.

17. The secure access method of claim 15, further comprising the step of forwarding information retrieved from said remote location corresponding to said requested physical key to said remote device in accordance with a location of said remote device forwarded from said remote device to said central device, and from said central device to said remote location.

18. The secure access method of claim 1, wherein said single secure access apparatus is associated with a restricted set of capabilities.

19. A secure access device utilization system, comprising:
a central device adapted to receive one or more physical electronic keys or software implemented electronic keys;
a remote device including a single secure access apparatus;
one or more remote storage locations, each being associated with one or more corresponding ones of said physical electronic keys or software implemented electronic keys;
wherein said remote device is authenticated by said central device in accordance with said single secure access apparatus, one of said one or more physical keys or software implemented electronic keys is requested by said remote device, and said remote storage location corresponding to said requested physical key or software implemented electronic keys is accessed.

20. The secure access device utilization system of claim 1, wherein information retrieved from said remote location corresponding to said requested physical key is forwarded to said central device, and then forwarded to said remote device from said central device.
